(19) United States
(12) Patent Application Publication
(10) Pub. No.: US 2010/0252740 A1
(43) Pub. Date: Oct. 7, 2010

(54) RADIATION IMAGING APPARATUS AND RADIATION IMAGING METHOD

(75) Inventors: Sadato AKAHORI, Ashigarakami-gun (JP); Tomonari SENDAI, Ashigarakami-gun (JP); Yasuko YAHIRO, Ashigarakami-gun (JP); Makoto SUGIZAKI, Ashigarakami-gun (JP); Naoto IWAKIRI, Ashigarakami-gun (JP); Yasunori OHTA, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/751,540

(22) Filed: Mar. 31, 2010

(30) Foreign Application Priority Data
Apr. 1, 2009 (JP) 2009-088755

(51) Int. Cl. G01N 23/04; G01J 1/42

(52) U.S. Cl. 250/360.1; 250/395

(57) ABSTRACT

Placement of a marker is performed efficiently, when performing a plurality of radiation imaging operations of a subject with different imaging angles. An operator inputs a region of interest within a subject on a bed, via an operating section. The region of interest and a peripheral region thereof are set as an irradiation range, and the marker is placed in the peripheral region. A radiation source control section causes a radiation source to emit radiation toward the subject within the set irradiation range. Radiation which passes through the subject is obtained by a radiation image detector as a radiation image.

### BACKGROUND OF THE INVENTION

1. Field of the Invention

The present invention is related to a radiation imaging apparatus and a radiation imaging method, for imaging a subject from a plurality of directions.

2. Description of the Related Art

Tomosynthesis images, in which structures at predetermined depths are emphasized, are generated by obtaining a plurality of radiation images by performing radiation imaging of subjects from a plurality of angles. In addition, three dimensional images (volume data) are generated by reconfiguring pluralities of radiation images. In these cases, a marker is placed at a predetermined position during obtainment of each radiation image, to perform positioning of a plurality of radiation images with respect to each other. The marker that appears within the radiation images are employed to perform positioning (refer to U.S. Pat. No. 5,706,324, and U.S. Patent Application Publication No. 20030043962).

Generally, the adjustment of the position of the marker is performed manually, based on the type of the subject, the position of an irradiation range, an imaging angle, and the like. However, manually setting the position of the marker for imaging operations of different subjects is troublesome. In addition, there are cases in which the marker is positioned within a region of interest, and become a cause of artifacts.

### SUMMARY OF THE INVENTION

The present invention has been developed in view of the foregoing circumstances. It is an object of the present invention to provide a radiation imaging apparatus and a radiation imaging method, in which a marker can be positioned accurately and efficiently, when performing a plurality of radiation imaging operations of a subject using different imaging angles.

A radiation imaging apparatus of the present invention comprises:

a radiation source, which is capable of irradiating radiation onto a subject from different angles;

a radiation image detector for detecting radiation, which has passed through the subject when the radiation is irradiated onto the subject by the radiation source, as a radiation image;

a marker for causing a marker image to appear within the radiation image, provided between the radiation source and the radiation image detector;

marker moving means for movably holding the marker within a range, within which the radiation image detector is capable of detecting radiation; and

marker position control means for controlling the operation of the marker moving means such that the marker is positioned within an irradiation range of the radiation irradiated by the radiation source.

A radiation imaging method of the present invention is a method that employs a radiation imaging apparatus comprising: a radiation source, which is capable of irradiating radiation onto a subject from different angles; a radiation image detector for detecting radiation, which has passed through the subject when the radiation is irradiated onto the subject by the radiation source, as a radiation image; a marker for causing a marker image to appear within the radiation image, provided between the radiation source and the radiation image detector; marker moving means for movably holding the marker within a range, within which the radiation image detector is capable of detecting radiation; and marker position control means for controlling the operation of the marker moving means, comprising the steps of:
irradiating radiation onto the subject from different angles; and
controlling the operation of the marker moving means such that the marker is positioned within irradiation ranges of the radiation irradiated by the radiation source.

Here, the configuration of the radiation source is not limited, as long as it is capable of irradiating radiation onto the subject form different angles. For example, the radiation source may be that which is configured to be movable in three dimensions, and the radiation image detector may move along with the movement of the irradiation range of the radiation source. Alternatively, the radiation image detector may be fixed at a certain position, and the radiation source may be of a configuration in which it changes the orientation of an aperture through which radiation is irradiated to face toward the radiation image detector, while it moves three dimensionally.

The marker is not particularly limited, as long as it is capable of causing the marker image to appear within the radiation image. The marker may be formed by a material having a low transmissivity with respect to radiation, or by a material having a high transmissivity with respect to radiation. The marker moving means may move the marker above or toward the side of the subject, may move the marker within the interior of a bed, or may move the marker between the bed and the radiation image detector.

Note that the radiation imaging apparatus may further comprise: irradiation range setting means for setting the irradiation range of the radiation irradiated by the radiation source; and region of interest setting means for setting a region of interest within the subject. In this case, the marker position control means controls the marker moving means such that the marker is placed in the vicinity of the region of interest set by the region of interest setting means; and the irradiation range setting means sets the irradiation range to include the region of interest and the region that the marker is placed in.

Alternatively, the irradiation range setting means may set a region of interest set by the region of interest setting means and a peripheral region in the periphery of the region of interest as the irradiation range. In this case, the marker position control means controls the marker moving means to place the marker within the peripheral region.

In addition, the marker position control means may control the marker moving means to move the marker such that the positional relationships among the marker, the radiation source, and the radiation image detector are substantially the same for each of a plurality of radiation imaging operations from different angles.

The radiation imaging apparatus of the present invention comprises: the radiation source, which is capable of irradiating radiation onto a subject from different angles; the radiation image detector for detecting radiation, which has passed through the subject when the radiation is irradiated onto the subject by the radiation source, as a radiation image; the marker for causing a marker image to appear within the radiation image, provided between the radiation source and the radiation image detector; the marker moving means for movably holding the marker within a range, within which the radiation image detector is capable of detecting radiation; and the marker position control means for controlling the operation of the marker moving means such that the marker is positioned within an irradiation range of the radiation irradiated by the radiation source. The radiation imaging method of the present invention employs the radiation imaging apparatus of the present invention. Therefore, the marker is automatically placed at appropriate positions according to the irradiation range of the radiation source. Accordingly, adjustments of marker placement can be efficiently and accurately performed.

A configuration may be adopted, wherein the radiation imaging apparatus further comprises: irradiation range setting means for setting the irradiation range of the radiation irradiated by the radiation source; and region of interest setting means for setting a region of interest within the subject. If this configuration is adopted, the marker position control means controls the marker moving means such that the marker is placed in the vicinity of the region of interest set by the region of interest setting means; and the irradiation range setting means sets the irradiation range to include the region of interest and the region that the marker is placed in. In this case, the marker can be automatically positioned outside of the region of interest. Accordingly, the occurrence of artifacts within three dimensional images generated by a plurality of radiation images can be suppressed.

Alternatively, if the above configuration is adopted, the irradiation range setting means may set a region of interest set by the region of interest setting means and a peripheral region in the periphery of the region of interest as the irradiation range. In this case, the marker position control means controls the marker moving means to place the marker within the peripheral region. In this case as well, the marker can be automatically positioned outside of the region of interest. Accordingly, the occurrence of artifacts within three dimensional images generated by a plurality of radiation images can be suppressed.

Further, the marker position control means may control the marker moving means to move the marker such that the positional relationships among the marker, the radiation source, and the radiation image detector are substantially the same for each of a plurality of radiation imaging operations from different angles. In this case, the marker can be positioned outside of the region of interest even when the angle at which radiation is irradiated onto the subject is changed. Accordingly, the occurrence of artifacts within three dimensional images can be suppressed.

### BRIEF DESCRIPTION OF THE DRAWINGS

FIG. 1 is a schematic diagram that illustrates a radiation imaging apparatus according to a first embodiment of the present invention.

FIG. 2 is a schematic diagram that illustrates the radiation imaging apparatus of the first embodiment.

FIG. 3 is a schematic diagram that illustrates the manner in which an irradiation range is set and a marker is positioned.

FIG. 4 is a flow chart that illustrates the steps of a radiation imaging method according to an embodiment of the present invention.

FIG. 5 is a schematic diagram that illustrates a radiation imaging apparatus according to a second embodiment of the present invention.

FIG. 6 is a schematic diagram that illustrates the positional relationship between an irradiating position and a marker in the radiation imaging apparatus of FIG. 5.

FIG. 7 is a schematic diagram that illustrates the manner in which the position of the marker is moved according to the movement of a radiation source.

FIG. 8 is a schematic diagram that illustrates a radiation imaging apparatus according to a third embodiment of the present invention.

FIG. 9 is a schematic diagram that illustrates a radiation imaging apparatus according to a fourth embodiment of the present invention.

### DESCRIPTION OF THE PREFERRED EMBODIMENTS

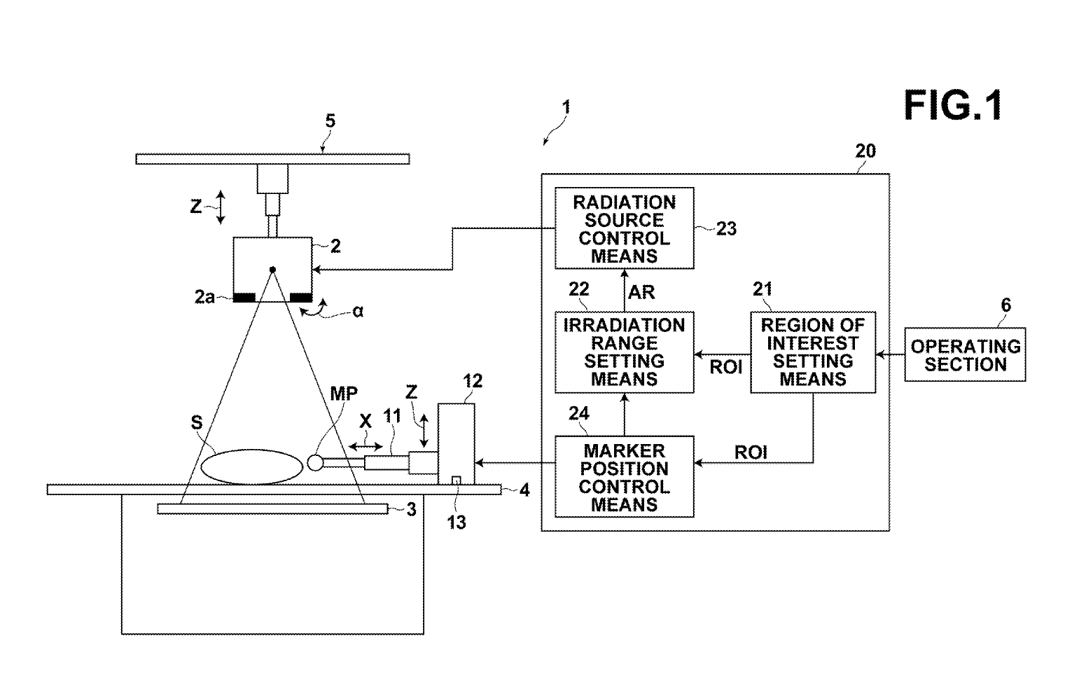

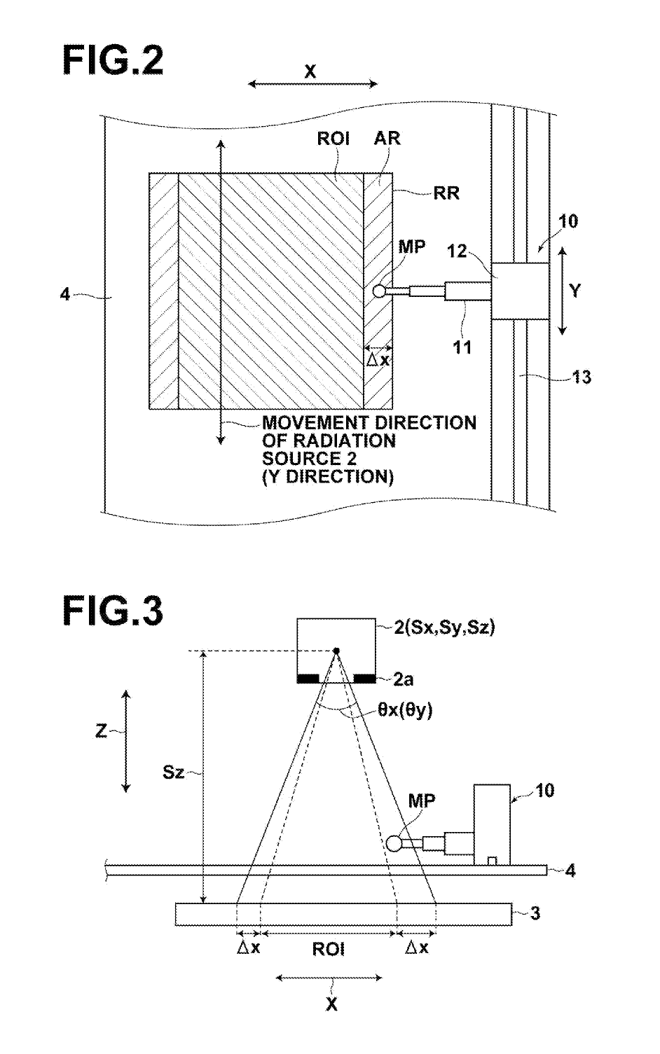

Hereinafter, embodiments of the radiation imaging apparatus of the present invention will be described in detail with reference to the attached drawings. FIG. 1 and FIG. 2 are schematic diagrams that illustrate a radiation imaging apparatus 1 according to a first embodiment of the present invention. The radiation imaging apparatus 1 is a radiation imaging apparatus which is capable of generating tomosynthesis data or volume data, and performs supine imaging. The radiation imaging apparatus 1 is equipped with: a radiation source 2, a radiation image detector 3; and an imaging control means 5. The radiation source 2 emits radiation onto a subject S, is movable in three dimensions (the X, Y, and Z directions) by a radiation source moving means 5, and held to be swayable in the directions indicated by arrow α. Further, the radiation source 2 is equipped with a collimator 2a. The collimator 2a changes the irradiation range of radiation emitted by the radiation source 2.

The radiation image detector 3 detects radiation, which has passed through the subject S when the radiation is irradiated onto the subject S by the radiation source, as a radiation image. The radiation image detector 3 is fixed beneath a bed 4 on which the subject S lays, and the irradiation range of the radiation source 2 is adjusted such that images of the subject S can be detected by the radiation image detector 3.

A marker MP is a sphere having a radius of 1 cm formed by a material such as lead, for example. Note that the marker is not particularly limited, as long as it is capable of causing the marker image to appear within the radiation image. The marker may be formed by a material having a low transmissivity with respect to radiation, or by a material having a high transmissivity with respect to radiation.

A marker moving means 10 functions to move the marker MP three dimensionally. The marker moving means 10 is equipped a telescoping rod 11, a drive means 12, and a rail 13. The telescoping rod 11 is extended and contracted by the drive means 12 in the direction indicated by arrow X, and holds the marker MP at the tip thereof. Further, the telescoping rod 11 is held by the drive means 12 to be movable in the direction indicated by arrow Z. The drive means 12 is provided on the rail 13, which extends in the direction indicated by arrow Y, and the telescoping rod 11 moves along the rail 13 in the direction indicated by arrow Y, by the driving means 12 being driven. Accordingly, the marker MP is in a state in which it is held to be movable in the X, Y, and Z directions by the marker moving means 10 above the bed 4.

An imaging control means 20 controls the operation of the radiation source 2, the radiation image detector 3, and the marker moving means 10. The imaging control means 20 is equipped with: a region of interest setting means 21; an irradiation range setting means 22; a radiation source control means 23; and a marker position control means 24. The region of interest setting means 21 sets a portion of the subject which is to be observed as a region of interest ROI. The region of interest setting means 21 sets the region of interest ROI according to input via an operating section 6 equipped with menu buttons or the like. Alternatively, the region of interest setting means 21 may set the region of interest ROI by detecting what region of the subject S is being irradiated by an irradiation field lamp. As a further alternative, a single or a plurality of preview imaging operations may be performed with a low radiation dosage, an operator may set the region of interest ROI based on one or more preview images obtained thereby, and the region of interest setting means 21 may detect the set region of interest ROI.

The irradiation range setting means 22 sets an irradiation range RR of radiation which is emitted form the radiation source 2. The radiation source control means 23 controls the operation of the radiation source 2 such that radiation is irradiated within the irradiation range RR set by the irradiation range setting means 22. Specifically, the radiation source control means 23 controls the operation of the collimator 2a (emission field aperture) of the radiation source 2, to set the irradiation range RR. The marker position control means 24 controls the marker moving means 10 to place the marker in a peripheral region AR.

The setting of the irradiation range RR and the positioning of the marker MP are performed in the following manner. First, when the region of interest setting means 21 sets the region of interest ROI, the irradiation range setting means 22 sets the region of interest ROI as a preliminary irradiation range RR. At this time, the preliminary irradiation range (x, y) at a height z has the relationships according to Formulas (1) and (2) below.

abs(sx−x)≦(sz−z)·tan (θx/2) (1)

abs(sy−y)≦(sz−z)·tan (θy/2) (2)

wherein the (sx, sy, sz) indicates the position of the radiation source 2, and θx and θy indicate aperture angles of the collimator 2a.

The marker position control means 24 calculates a preliminary irradiation range (x, y) at a height position z of the marker MP, which is known. Then, the marker position control means 24 sets a peripheral region (x+Δx, y) about the periphery of the preliminary irradiation range (x, y) as the peripheral region AR (the value of Δx is set in advance). That is, in the case that the movement direction of the radiation source 2 is the Y direction, the marker position control means 24 sets the peripheral region AR such that the irradiation range (x, y) is expanded in a direction (the direction indicated by arrow X) perpendicular to the direction of movement. Thereafter, the marker position control means controls the marker moving means 10 such that the marker MP is placed within the peripheral region AR (x+Δx, y).

Meanwhile, the radiation source control means 23 calculates aperture angles θx and θy in the case that the peripheral region AR is included in the irradiation range (x, y) using Formulas (1) and (2), then controls the collimator 2a of the radiation source 2. Note that a plurality of radiation imaging operations are performed to generate tomosynthesis data and volume data. Therefore, the aperture angles θx and θy are adjusted for each radiation imaging operation.

Note that a case has been described in which the marker placement position and the irradiation range RR are set after the region of interest ROI has been set. Alternatively, the irradiation range RR may be set first, then the placement position of the marker MP may be set. That is, when the region of interest ROI is set, the irradiation range setting means 22 sets the region of interest ROI and the peripheral region AR as the irradiation range RR. Thereafter, the radiation source control means 23 sets the aperture angles θx and θy according to the set irradiation range. Meanwhile, the marker position control means 24 controls the marker moving means 10 such that marker MP is placed within the peripheral region AR set by the irradiation range setting means 22.

The position of the marker MP is automatically set in this manner. Therefore, the position of the marker MP can be set efficiently and accurately. In the case that an operator sets the position of the marker MP manually in a conventional manner, there are cases in which problems, such as the marker MP not being placed within the irradiation range of radiation, or the marker MP being within a region of interest ROI, occur, in addition to being troublesome. In contrast, by automatically moving the marker MP outside the region of interest ROI and within the irradiation range as described above, the position of the marker MP can be automatically set efficiently and accurately. Further, by setting the peripheral region AR to be an expansion of the irradiation range RR in a direction perpendicular to the movement direction of the radiation source 2, the position of the marker MP can be maintained outside the region of interest ROI, regardless of the movement of the radiation source 2.

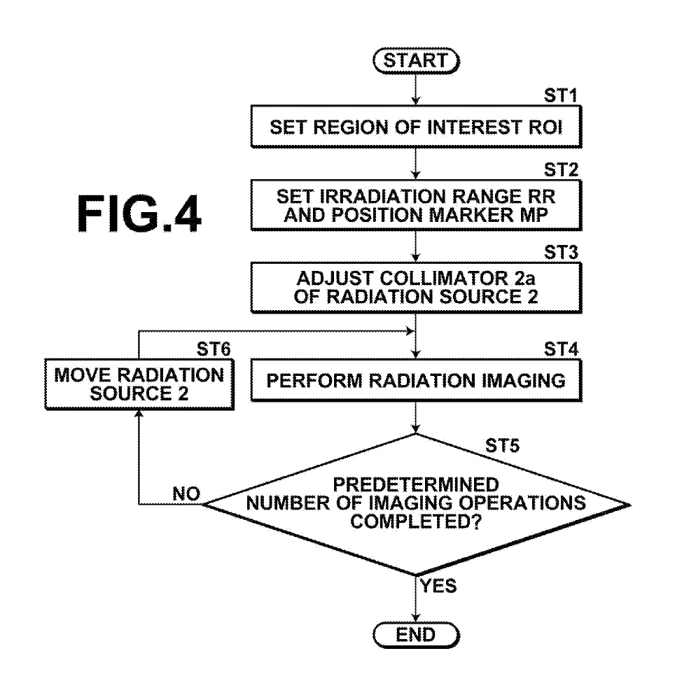

FIG. 4 is a flow chart that illustrates the steps of a radiation imaging method according to an embodiment of the present invention. The radiation imaging method of the present invention will be described with reference to FIGS. 1 through 4. First, an operator inputs a region of interest ROI with respect to a subject S on the bed 4 via the operating section 6 (step ST1). Then, the irradiation range setting means 22 sets the region of interest ROI and a peripheral region AR thereof as an irradiation range RR, and the marker MP is placed within the peripheral region by the marker moving means 10 under control of the marker position control means (step ST2). Further, the radiation source control means 23 controls aperture angles θx and θy of the collimator 2a such that radiation is irradiated within the set irradiation range RR (step ST3).

In this state, radiation is emitted toward the subject S from the radiation source 2, and the radiation which has passed through the subject S is obtained by the radiation image detector 3 as a radiation image (step ST4). Thereafter, the imaging control means 20 judges whether a predetermined number of imaging operations have been completed (step ST5). In the case that the result of judgment is negative, the radiation source 2 is moved to a next position (step ST6), and radiation imaging from a different imaging angle is performed (steps ST3 through ST6). The aperture angles θx and θy are calculated for each radiation imaging operation accompanying a change in the imaging angle. Note that the position of the marker MP, which is employed to position a plurality of radiation images with respect to each other, is not changed among the plurality of radiation imaging operations.

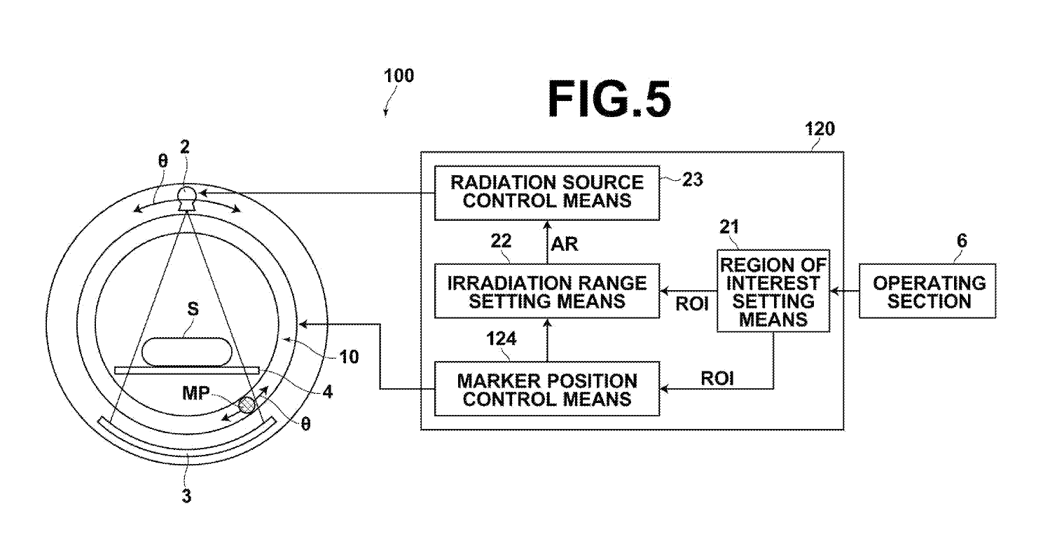

FIG. 5 is a schematic diagram that illustrates a radiation imaging apparatus 100 according to a second embodiment of the present invention. The radiation imaging apparatus 100 will be described with reference to FIG. 5. Note that elements of the radiation imaging apparatus 100 which are the same as those of the radiation imaging apparatus 1 illustrated in FIGS. 1 through 3 will be denoted with the same reference numerals, and detailed descriptions thereof will be omitted. The radiation imaging apparatus 100 of FIG. 5 differs from the radiation imaging apparatus 1 of FIGS. 1 through 3 in the placement position of the marker MP, and that the marker MP is moved each time that the angle of radiation imaging operations is changed.

FIG. 5 illustrates an example in which the radiation imaging apparatus 100 is a dome shape CT apparatus. In the radiation imaging apparatus 100, the radiation source 2 and the radiation image detector 3 rotate about the periphery of a subject S in the directions denoted by arrow θ. In addition, the marker MP is held by the marker moving means 10 so as to rotate about the inner periphery of the radiation source 2 and the radiation image detector 3 in the directions indicated by the arrow θ.

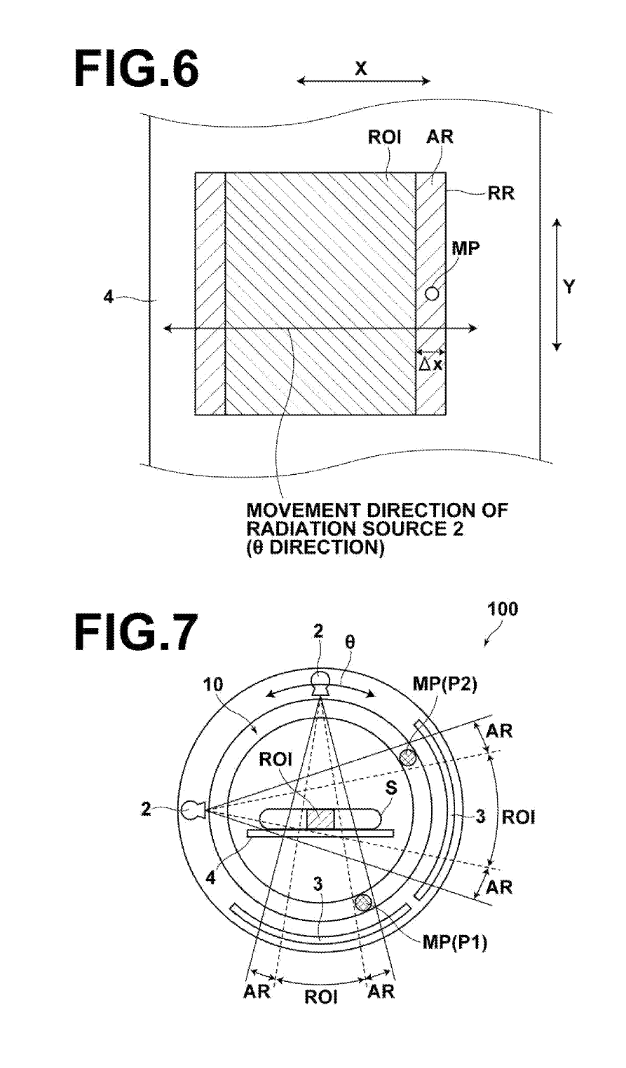

As illustrated in FIG. 6, a marker position control means 124 sets a region which is expanded for θy toward a direction (indicated by the arrow Y) along the movement direction of the radiation source 2 (the θ direction) as a peripheral region AR, and controls the marker moving means 10 such that the marker MP is positioned within the peripheral region AR. Alternatively, in the case that the irradiation range RR is set as the region of interest ROI and the peripheral region AR, the marker MP is placed along the direction of movement of the radiation source 2 (the direction indicated by the arrow Y).

Further, as illustrated in FIG. 7, the marker position control means 124 controls the marker moving means 10 to move the marker MP to a position within the irradiation range RR and outside the region of interest ROI, when the radiation source 2 and the radiation image detector 3 move in the direction of arrow θ. For example, consider a case in which the radiation source 2 is positioned at an irradiating position S1 directly above the subject, and the marker MP is placed at a position P1 outside the region of interest ROI. Thereafter, if the radiation source 2 is moved to an irradiating position S2, there are cases in which the marker MP, which is placed at position P1, is not within the irradiation range RR, or is within the region of interest ROI.

Therefore, the marker position control means 124 sets the peripheral region AR adjacent to the region of interest ROI and moves the marker MP to the set peripheral region AR each time that the radiation source 2 is moved. Specifically, the marker position control means 124 controls the marker moving means 10 to move the marker MP from position P1 to position P2, such that the positional relationships among the marker MP, the radiation source 2, and the radiation image detector 3 are substantially the same at any radiation imaging position. That is, the marker MP is moved along with the movement of the radiation source 2 in step ST6 of FIG. 4.

Thereby, the marker MP can always be placed outside the region of interest ROI. Accordingly, the generation of artifacts caused by images of the marker MP being pictured within the region of interest ROI can be suppressed. That is, in the case of the dome type CT apparatus illustrated in FIG. 7, the movement of the marker MP is restricted, and there are cases in which the marker MP cannot be placed in a peripheral region AR, which is an expansion in a direction perpendicular to the movement direction of the radiation source 2 (refer to FIG. 2). Even in such cases, the marker MP can be positively placed outside the region of interest ROI and within the irradiation range RR, as illustrated in FIG. 5 through FIG. 7. Note that when positioning a plurality of radiation images based on the marker MP during generation of tomosynthesis data and volume data, the spatial position of the marker MP is known. Therefore, the relationship between the spatial position of the marker and projected positions thereof within the radiation images can be understood based on the geometric position of the marker MP, and the positioning is performed based on the projected positions of the marker.

The embodiments described above are equipped with: the radiation source 2, which is capable of irradiating radiation onto the subject S from different angles; the radiation image detector 3 for detecting radiation, which has passed through the subject S when the radiation is irradiated onto the subject by the radiation source 2, as a radiation image; the marker MP for causing a marker image to appear within the radiation image, provided between the radiation source 2 and the radiation image detector 3; the marker moving means 10 for movably holding the marker within a range, within which the radiation image detector is capable of detecting radiation; and the marker position control means 24 for controlling the operation of the marker moving means 10 such that the marker MP is positioned within an irradiation range RR of the radiation irradiated by the radiation source. Therefore, the marker MP is automatically placed at appropriate positions according to the irradiation range RR of the radiation source 2. Accordingly, adjustments of marker placement can be efficiently and accurately performed.

The radiation imaging apparatus further comprises: the irradiation range setting means 22 for setting the irradiation range RR of the radiation irradiated by the radiation source; and the region of interest setting means 21 for setting a region of interest ROI within the subject. The marker position control means 24 controls the marker moving means 10 such that the marker MP is placed in the vicinity of the region of interest ROI set by the region of interest setting means 21; and the irradiation range setting means 22 sets the irradiation range RR to include the region of interest ROI and the region that the marker MP is placed in. Therefore, the marker MP can be automatically positioned outside of the region of interest ROI. Accordingly, the occurrence of artifacts within three dimensional images generated by a plurality of radiation images can be suppressed.

Alternatively, the irradiation range setting means 22 may set a region of interest ROI set by the region of interest setting means 21 and a peripheral region AR in the periphery of the region of interest ROI as the irradiation range RR. In this case, the marker position control means 24 controls the marker moving means 10 to place the marker MP within the peripheral region AR. In this case as well, the marker MP can be automatically positioned outside of the region of interest ROI. Accordingly, the occurrence of artifacts within three dimensional images generated by a plurality of radiation images can be suppressed.

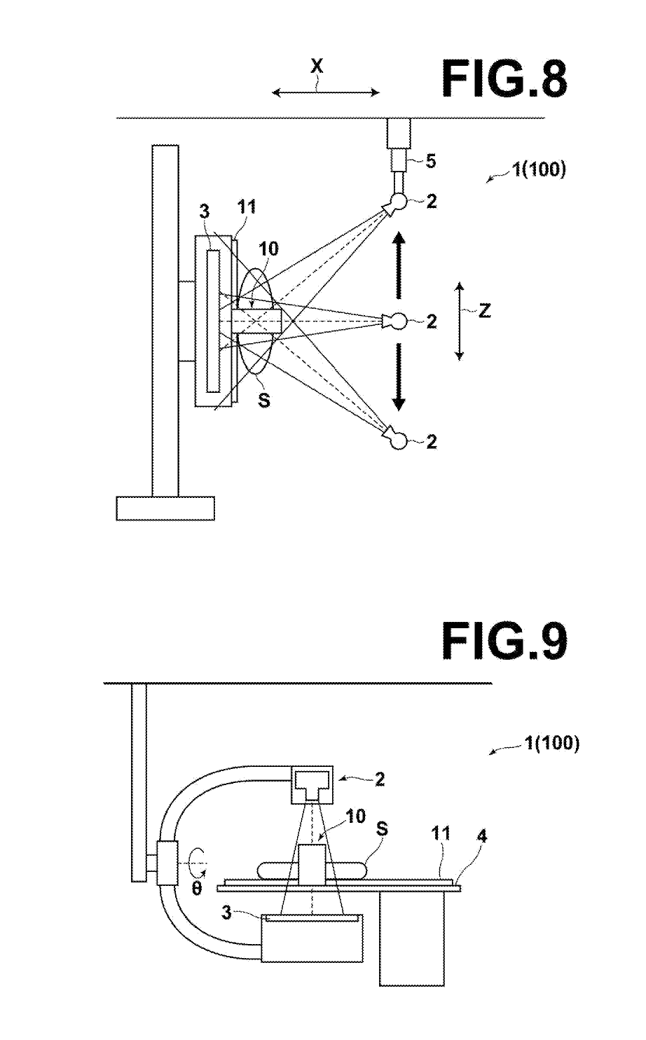

The present invention is not limited to the embodiments described above. For example, the embodiment illustrated in FIG. 1 through FIG. 3 illustrate is a radiation imaging apparatus 1 that performs supine imaging, and the embodiment illustrated in FIG. 5 is a dome type CT apparatus. However, the embodiment described with reference to FIG. 5 through FIG. 7 may be applied to the supine type radiation imaging apparatus of FIG. 1, and the embodiment described with reference to FIG. 1 through FIG. 3 may be applied to the dome type CT apparatus of FIG. 5. Further, the present invention may also be applied to an upright type radiation imaging apparatus illustrated in FIG. 8 and the C arm type CT apparatus illustrated in FIG. 9.

In addition, FIG. 7 and FIG. 8 illustrate cases in which the position of the marker MP is moved for each radiation imaging operation. However, the marker MP will not be pictured within the region of interest ROI if the change in imaging angle is slight. Therefore, a configuration may be adopted, wherein the position of the marker MP is not moved until the imaging angle of the radiation source 2 changes a predetermined amount, and the position of the marker MP is moved each time that the radiation source 2 moves 30 degrees, for example.

What is claimed is:

1. A radiation imaging apparatus, comprising:
a radiation source, which is capable of irradiating radiation onto a subject from different angles;
a radiation image detector for detecting radiation, which has passed through the subject when the radiation is irradiated onto the subject by the radiation source, as a radiation image;
a marker for causing a marker image to appear within the radiation image, provided between the radiation source and the radiation image detector;
marker moving means for movably holding the marker within a range, within which the radiation image detector is capable of detecting radiation; and
marker position control means for controlling the operation of the marker moving means such that the marker is positioned within an irradiation range of the radiation irradiated by the radiation source.

2. A radiation imaging apparatus as defined in claim 1, further comprising:
irradiation range setting means for setting the irradiation range of the radiation irradiated by the radiation source; and
region of interest setting means for setting a region of interest within the subject; and wherein:
the marker position control means controls the marker moving means such that the marker is placed in the vicinity of the region of interest set by the region of interest setting means; and
the irradiation range setting means sets the irradiation range to include the region of interest and the region that the marker is placed in.

3. A radiation imaging apparatus as defined in claim 1, further comprising:
irradiation range setting means for setting the irradiation range of the radiation irradiated by the radiation source; and
region of interest setting means for setting a region of interest within the subject; and wherein:
the irradiation range setting means sets the irradiation range to include the region of interest and a peripheral region about the periphery of the region of interest; and
the marker position control means controls the marker moving means such that the marker is placed in the peripheral region.

4. A radiation imaging apparatus as defined in claim 1, wherein:
the marker position control means controls the marker moving means to move the marker such that the positional relationships among the marker, the radiation source, and the radiation image detector are substantially the same for each of a plurality of radiation imaging operations from different angles.

5. A radiation imaging method that employs a radiation imaging apparatus comprising: a radiation source, which is capable of irradiating radiation onto a subject from different angles; a radiation image detector for detecting radiation, which has passed through the subject when the radiation is irradiated onto the subject by the radiation source, as a radiation image; a marker for causing a marker image to appear within the radiation image, provided between the radiation source and the radiation image detector; marker moving means for movably holding the marker within a range, within which the radiation image detector is capable of detecting radiation; and marker position control means for controlling the operation of the marker moving means, comprising the steps of:
irradiating radiation onto the subject from different angles; and
controlling the operation of the marker moving means such that the marker is positioned within irradiation ranges of the radiation irradiated by the radiation source.

6. A radiation imaging method as defined in claim 5, further comprising the steps of:
setting a region of interest within the subject when setting the position of the marker;
setting the set region of interest and a peripheral region about the periphery of the region of interest as the irradiation ranges; and
controlling the marker moving means such that the marker is positioned within the set peripheral region.

7. A radiation imaging method as defined in claim 5, further comprising the steps of:
setting a region of interest within the subject when setting the irradiation ranges;
controlling the marker moving means such that the marker is positioned in the vicinity of the set region of interest; and
setting the irradiation ranges such that they include the region of interest and the region that the marker is placed in.
